(19) United States
(12) Patent Application Publication
(10) Pub. No.: US 2006/0003124 A1
(43) Pub. Date: Jan. 5, 2006

(54) Rotating body for image forming apparatus

(75) Inventor: Kazuya Takatoh, Minato (JP)

Correspondence Address: LAU & ASSOCIATES, 7701 ROCKLEDGE COURT, SPRINGFIELD, VA, 22152, US

(73) Assignee: Nitto Kogyo Kabushiki Kaisha

(21) Appl. No.: 11/171,237

(22) Filed: Jul. 1, 2005

(30) Foreign Application Priority Data
Jul. 5, 2004 (JP) 2004-197784

(51) Int. Cl. B32B 27/06; B32B 15/04

(52) U.S. Cl. 428/35.7; 428/457; 428/473.5; 428/447

(57) ABSTRACT

A rotating body for an image forming apparatus is provided having a substrate; and a covering layer adhered to the surface of the substrate, the surface being subjected to activation by silicifying it with flame. The rotating body of present invention can exhibit excellent adhesiveness between the substrate and the covering layer, even if primer treatment is not carried out on the surface of the substrate.

### FIELD OF THE INVENTION

The present invention relates to a rotating body used in an image forming apparatus such as a copier, a printer and a facsimile machine.

### DESCRIPTION OF THE RELATED ART

A rotating body used in an image forming apparatus, such as a roller, an endless belt or a sleeve is prepared by forming a primer layer on the surface of a substrate made of inorganic material such as metal, ceramic and the like, or organic material such as synthetic polymeric resin to improve adhesiveness, and then applying a covering layer such as an elastic layer or a releasing layer thereto, which is disclosed, for example, in Japanese Laid open Publication No. 2002-337161.

However, several problems became evident when primer treatment was carried out for the purpose of improving adhesiveness. Specifically, one problem arose when forming a primer layer over the surface of a substrate made of metal or an organic material such as synthetic polymeric resin. When these materials were utilized as a substrate, it has been necessary to carry out the steps of baking and cooling after applying a primer thereon.

Another problem was that, in the case of using a substrate made of metal such as iron for improving adhesiveness, pretreating the surface of a metal substrate, for example, by means of sandblast, and cleaning and drying the substrate thus obtained were needed, prior to application of a primer.

There has been occurred still another problem that, in the case of utilizing a metallic core shaft, since a primer layer had a tendency to degrade depending upon the kind of metal being used, it was impossible to use metal such as stainless steel, nickel and the like which are excellent in anti-corrosiveness. Therefore, in the case of utilizing a substrate made of iron, in order to prevent corrosion of its exposed portion which was not covered with a covering layer, the surface of a substrate had to be coated with steel materials comprising an amount of less than 10% of chromium, as disclosed in the Japanese Laid open Publication No. 2002-337161 as its prior art. Alternatively, nickel plating might be applied to the exposed portion of a substrate for the prevention of corrosion. However, because such plating had to be performed on a substrate only prior to the formation of a covering layer thereon, and there was no effective masking method to ensure that the portion to be coated should not be nickel-plated, a method comprising the steps of plating the whole of a core shaft surface with nickel, and then removing nickel-plated layer thus obtained from the portion to be covered with a covering layer thereon, selectively by means of abrasion and the like has been suggested, however this method has been time-consuming.

Further problems were that, in case a reagent used in primer treatment comprised a solvent as one of its components, 1) the solvent should be dried in a furnace, which needs a high investment in facility cost and high running cost, for a short period of time, 2) the solvent and its vapor should be removed, purified and/or treated through an additional after-treatment process, and 3) a possibility of contaminating ambient air should be eliminated while the solvent being dried.

As described above, the conventional primer treatment should be performed in multi-stages, resulting in the need for a high investment in facility cost and high running cost. Moreover, an effective solution to prevent air contamination has also been needed.

### SUMMARY OF THE INVENTION

The present invention relates to a rotating body for an image forming apparatus, having a substrate and a covering layer adhered to the surface of the substrate. According to the present invention, to achieve high adhesive strength between the substrate and the covering layer, the surface of the substrate is subjected to activation by silicifying it with flame.

### DISCLOSURE OF THE INVENTION

In order to solve the above problems, the present inventors have focused on shortening process steps, decreasing cost needed for running and maintaining facilities, and preventing air contamination due to a solvent used in the primer treatment.

According to the present invention, the afore-mentioned subjects can be solved by using a rotating body for an image forming apparatus, comprising a substrate and a covering layer adhered to the substrate, the surface of the substrate being activated by silicifying it with flame.

In preferred embodiments of the present invention, a rotating body can exhibit excellent adhesiveness between its substrate and covering layer, although a combination of a substrate and a covering layer is used representing only poor adhesiveness therebetween, even after primer treatment executed thereon. In preparing a rotating body according to an embodiment of the present invention, primer treatment is not needed to perform, and accordingly the steps as required in the prior art, such as applying, baking and cooling of a primer, are also not needed any more; and purification/or treatment of solvent or its vapor as required in case that a reagent used in primer treatment comprises a solvent as one of its components, is not needed to perform any more. Accordingly, a cost-effective process can be realized and there is no fear of an adverse effect on environment.

With respect to activation by silicification with flame, an integral period of time required to treat a desired portion of the surface of a substrate is extremely short, for example, less than 1 second. Therefore, a material with poor heat-resistance can also be subjected to activation by silicifying it with flame. Besides, there is no need to apply, bake and cool a primer, as conducted in the prior art, and therefore the present invention can be carried out within a considerably decreased period of time in comparison with the prior art.

Further, in an embodiment of the present invention, there is no need to apply a primer on a metal substrate, as required in the prior art and, as a result, pre-treatment such as sandblast and after-treatment such as cleaning, drying and the like can be omitted. Therefore, a cost-effective process can be achieved according to the present invention.

In an embodiment of the present invention, any substrate suited to a rotating body for an image forming apparatus may be preferably used as a substrate material. For example, a substrate comprises a roller-shaped substrate, an endless belt-shaped substrate, or a sleeve-shaped substrate which may be a flexible cylindrical substrate. A substrate may be made of inorganic material such as metal and metal alloys, organic material or a combination thereof. A substrate may be made of two different materials, each of which may comprise an inner portion and an outer portion of the substrate. For example, the outer portion of the substrate may be made of metal or synthetic polymeric resin.

Among these, a substrate suited to a roller (i.e. a core shaft material suited to a roller) may include inorganic material having a high rigidity, such as metal or metal alloys, preferably iron, iron-stainless steel alloy, nickel-plated iron and its alloy to impart increased corrosion resistance thereto, aluminum and its alloys, nickel, copper and its alloys and the like.

Meanwhile, a substrate suited to an endless belt which is formed in an endless manner, has a high flexibility and may be also designated as a sleeve or a film, may include relatively thin metal such as stainless steel and nickel; heat-resistant synthetic polymeric resin such as polyimide, polyamide, polyethersulfone and the like; synthetic polymeric resin such as polyethylene, polycarbonate, polyethyleneterephthalate and the like. If necessary, the substrate may be covered with a covering layer made of synthetic polymeric resin, ceramic and so on.

In preferred embodiments of the invention, the surface of the substrate can be activated by silicifying it with flame. Such activation makes it possible to prepare a covering layer securely adhered to the substrate, without primer treatment.

Such activation results in providing an active functional group on the surface of the substrate. The functional group includes, for example, carboxyl group (—COOH), silanol group (Si—OH), hydroxyl group (—OH) and the like. In the present invention, it is also to be understood that hydroxyl group may be included in carboxyl group, silanol group and the like. According to the practice of the present invention, activation of the surface of a substrate is carried out, for example, by silicification with flame. Specifically, by silicification with flame, we mean a method comprising formation of a flame near from the surface of a substrate, and reaction the surface of the substrate with a silicon-based compound in the flame.

Such silicon-based compound may include an organic silicon-based compound, for example, alkoxysilanes such as tetramethoxysilane, methyltriethoxysilane, methyltrimethoxysilane, dimethyldiethoxysilane, dimethyldimethoxysilane and the like.

In an embodiment of the present invention, the flame suited for burning may be prepared by, for example, burning mist of liquid-vapor mixture of the organic silicon-based compound or vapor of the same compound. Typically, flame for silicification is prepared by burning combustible gas such as propane gas, butane gas, LPG (liquid petroleum gas), LNG (liquefied natural gas) and the like to form a flame, and at the same time providing oxygen gas or air thereto; and providing the vapor of organic silicon-based compound in the flame or spraying an organic silicon-based compound into the flame, to form flame for silicification.

In an embodiment of the present invention, activation process can be carried out by using the flame for silicification thus prepared. During activation, an integral period of time for a desired portion of the surface of a substrate is extremely short, for example, less than 1 second. Usually, to prevent the deformation or degradation of the substrate by heat generated by the flame, for the desired portion on the substrate, the flame should be treated thereon while being migrated promptly, and therefore the temperature of the corresponding portion on the substrate does not rise dramatically.

As described above, the integral period of time for the desired portion of the substrate to be exposed to the flame, may be less than 1 second, particularly 0.5 to 1 second. Therefore, even if an organic material such as synthetic polymeric resin is used as a substrate, it is not adversely affected by heat generated by flame.

As silicon dioxides may be formed on at least a portion of the surface of the substrate due to such silicification with flame, we define this reaction as combustion chemical vapor phase deposition, which means a chemical vapor phase deposition(CVD) accompanied by combustion. For a reference, the presence of silicon dioxides (for example, the presence of Si—O—Si or Si—OH bonding etc.) could be identified by using its characteristic absorption peak by means of FT-IR spectroscopy. The intensity of flame for silicification can be determined or controlled in proportion to the intensity of corresponding absorption peak.

In an embodiment of the present invention, silicification with flame includes, for example, combustion chemical vapor phase deposition used to improve printablilty, as disclosed in the Japanese Patent Laid open Publication No. 2002-53982.

Silicification with flame may be carried out either once or multiple times. However, to ensure that advantages of the present invention are achieved, silicification with flame is preferably carried out repeatedly.

Moreover, in order to increase beneficial effects according to the present invention, prior to silicification with flame, the surface of the substrate is preferably treated with oxidized flame at least once. According to the practice of the present invention, the term treatment with oxidized flame is defined as treatment that the surface of the substrate is treated with an oxidized flame portion of burning flame which is made of combustible gas and the like. As the same manner in the silicification with flame, to prevent the deformation or degradation of the substrate by heat generated by the flame, for the desired portion on the substrate, the flame should be treated thereon while being migrated promptly, and therefore the temperature of the corresponding portion on the substrate does not rise dramatically.

It is necessary to apply a covering layer to the surface of the substrate silicified with flame as described above, to achieve a desired adhesiveness. In preferred embodiments of the present invention, a covering layer may be any covering layer which is suitable for use in a rotating body for an image forming apparatus, and includes, for example, a rubber such as a silicone rubber, an urethane rubber, an ethylenepropylene (EP) rubber, an ethylenepropylenediene (EPDM) rubber and the like, and a cellular porous medium thereof; a fluororesin; an urethane resin; a polyethylene resin and the like. The cellular porous medium may comprise an open-cell type or a closed-cell type.

A rotating body for an image forming apparatus according to the present invention is preferably used as, for example, a roller, an endless belt, a sleeve and the like. Preferably, it can be used as a rotating body to secure a fixing device to an image forming apparatus, and can be subjected to heating.

In an embodiment of the present invention, a rotating body for an image forming apparatus can be used at a relatively high temperature and can include, for example, a fixing roller, a fixing belt or a fixing sleeve.

When a silicone rubber is applied to the surface of the rotating body as a covering layer, by means of a conventional primer treatment, the primer layer degrades due to heat applied thereto, and therefore the life-time of a rotating body itself decreases considerably. Contrary to conventional technologies, the present invention would not require such primer treatment to be performed, and therefore thermal degradation problem would never happen. Moreover, even at a high temperature, a desired durability can be achieved in the present invention. The rotating body in accordance with the present invention is particularly suitable for a fixing rotating body.

FIG. 1 is a cross-sectional view of an embodiment of the rotating body used in an image forming apparatus, according to the present invention. The surface of a substrate 1 which is silicified with flame is covered with a covering layer 2.

The present invention will be described below by way of its Examples. However, the present invention should not be limited by these Examples.

### BRIEF DESCRIPTION OF THE DRAWING

FIG. 1 is a cross-sectional view schematically exemplifying a rotating body for an image forming apparatus according to the present invention.

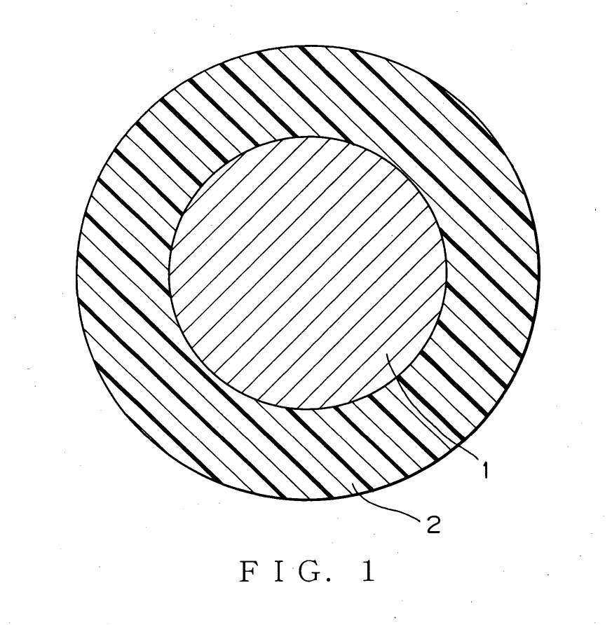

### DESCRIPTION OF THE PREFERRED EMBODIMENTS

### COMPARATIVE EXAMPLE 1

A polyimide-based belt commercially available from GUNZE Ltd., having an inner diameter of 60 mm, a thickness of 90 μm and a width of 330 mm was used as a substrate. The belt was washed with water and then dried.

### COMPARATIVE EXAMPLE 2

A belt was prepared as in comparative example 1. To this belt was applied a primer material (DOW CORNING CORP., DY39-042). The belt was then baked and cooled to provide the belt of comparative example 2.

### EXAMPLE 1

Tetramethoxysilane was introduced in the flame which was formed by oxygen gas and liquefied natural gas. The surface of a belt prepared as in comparative example 1 was heated with the flame for a short period of time to provide the belt of example 1.

Preparation of Samples

Each of samples was independently originated from the belts of comparative example 1, 2 and example 1. Each of samples was subjected to heating together with a silicone rubber (DOW CORNING CORP., DY35-796) at a temperature of 130° C. for 25 minutes to provide three belts each covered with the silicone rubber layer having a thickness of 1 mm and ASKER-C hardness of 24 degree.

Adhesiveness test

For these three samples, crosscut test was carried out to evaluate their adhesiveness. Specifically, eleven horizontal and eleven vertical cuts were made in the square 1 cm wide by 1 cm long of individual covering layers with a knife respecting a distance of 1 mm between parallel cuts. Approximately 100 crosscut-test areas were made per sample. The cross cut areas were covered with the silicone rubber layer that was then tried to remove by hand. The crosscut area was then visually inspected and evaluated. As a result, in the comparative example 1, almost all coating squares were removed (poor adhesiveness). On the contrary, in the comparative example 2 and example 1, no coating square was removed (excellent adhesiveness).

The adhesiveness test results demonstrate that the example 1 according to the present invention has at least the same adhesiveness as covering layer prepared by carrying out the prior art primer treatment has. The time (sec.) required for carrying out each of steps before applying a covering layer on the surface of the substrate is set out below in Table 1.

As shown in Table 1, the polyimide belt silicified with flame according to the present invention enables the total time required for carrying out the process to decrease dramatically, compared with the prior art.

### COMPARATIVE EXAMPLE 3

As a substrate, an aluminum core shaft with 36 mm of diameter, prepared as in comparative example 1 was used. No treatment was practiced on the surface of the substrate.

### COMPARATIVE EXAMPLE 4

Comparative example 4 was prepared as in comparative example 2, substituting the same aluminum core shaft as that of comparative example 3 for a polyimide belt.

### COMPARATIVE EXAMPLE 5

Comparative example 5 was prepared as in comparative example 4, except that the surface of the core shaft was sandblasted, washed with water and dried prior to primer treatment.

### EXAMPLE 2

Example 2 was prepared as in example 1, substituting the same aluminum core shaft as that of comparative example 3 for a polyimide belt.

Preparation of Samples

Each of samples was independently originated from the core shaft of comparative example 3, 4 and 5, and example 2. Each of samples was subjected to heating together with a silicone rubber (DOW CORNING CORP., DY35-796) at a temperature of 130° C. for 25 minutes to provide four core shafts each covered with the silicone rubber layer having a thickness of 2 mm and ASKER-C hardness of 24 degree.

Adhesiveness test

For these four samples, crosscut test was carried out to evaluate their adhesiveness. Specifically, four horizontal and four vertical cuts were made in the square 9 mm wide by 9 mm long of individual covering layers with a knife respecting a distance of 3 mm between parallel cuts. 9 crosscut-test areas were made per sample. The cross cut areas were covered with the silicone rubber layer that was then tried to remove by hand. The crosscut area was then visually inspected and evaluated. As a result, in the comparative example 3, almost all coating squares were removed (poor adhesiveness). In the comparative example 4, coating squares were released partially, but not released completely from the surface of the aluminum core shaft. In the comparative example 5 and example 2, no coating square was removed (excellent adhesiveness).

The adhesiveness test results demonstrate that the example 2 according to the present invention has at least the same adhesiveness as the prior art covering layer prepared by carrying out primer treatment and pretreatment such as sandblast has. Therefore, in the present invention, there is no need to apply a primer on the surface of a substrate, as required in the prior art, and as a result, pretreatment such as sandblast and after-treatment such as cleaning, drying and the like can be omitted.

The time (min.) required for carrying out each of steps before applying a covering layer on the surface of the substrate is set out below in Table 1. As shown in Table 1, the aluminum core shaft silicified with flame according to the present invention enables the total time required for carrying out the process to decrease dramatically, compared with the prior art.

TABLE 1

| | Polyimide belt | | | Aluminum core shaft | | | |
|---|---|---|---|---|---|---|---|
| | | Com. | Com. | | Com. | Com. | Com. Ex. |
| | Ex. 1 | Ex. 1 | Ex. 2 | Ex. 2 | Ex. 3 | Ex. 4 | 5 |
| washing & drying | 1 | 1 | 1 | 9 | 9 | 9 | 9 |
| sandblast | — | — | — | — | — | — | 0.5 |
| washing & drying | — | — | — | — | — | — | 9 |
| primer application | — | — | 1 | — | — | 1 | 1 |
| baking | — | — | 30 | — | — | 30 | 30 |
| cooling | — | — | 20 | — | — | 20 | 20 |
| Silicification with | 0.03 | — | — | 0.03 | — | — | — |
| flame | | | | | | | |
| total | 1.03 | 1 | 52 | 9.03 | 9 | 60 | 60.5 |

Various modifications and alterations of this invention will be apparent to those skilled in the art without departing from the scope and spirit of this invention and this invention should not be restricted to that set forth herein for illustrative purposes.

What is claimed is:

1. A rotating body for an image forming apparatus comprising:
a substrate; and
a covering layer adhered to the surface of the substrate, whereby the surface of the substrate is subjected to an activation by silicifying it with flame.

2. The rotating body as claimed in claim 1, Wherein said activation is a treatment to react the surface of the substrate with a silicon compound in a burning flame.

3. The rotating body as claimed in claim 2, wherein said activation results in forming or providing a hydroxyl group as an active group on the surface of the substrate.

4. The rotating body as claimed in claim 1, wherein said activation is carried out by means of combustion chemical vapor phase deposition to form silicon oxide on the surface of the substrate.

5. The rotating body as claimed in claim 1, wherein said activation is preceded by at least one time oxidized flame treatment.

6. The rotating body as claimed in claim 1, wherein at least the surface of the substrate is comprised of a metal or a synthetic polymeric resin.

7. The rotating body as claimed in claim 6, wherein said metal is selected from a group of iron, aluminum, stainless steel, nickel and copper.

8. The rotating body as claimed in claim 6, wherein said synthetic polymeric resin is polyimide.

9. The rotating body as claimed in claim 6, wherein the substrate is a core shaft or an endless belt.

10. The rotating body as claimed in claim 1, wherein the covering layer comprises an elastic material.

11. The rotating body as claimed in claim 10, wherein the elastic material is a silicone rubber.

12. The rotating body as claimed in claim 1, wherein the rotating body is a fixing rotating body used in a fixing device.
